(19) United States
(12) Patent Application Publication
(10) Pub. No.: US 2016/0183321 A1
(43) Pub. Date: Jun. 23, 2016

(54) METHOD AND APPARATUS FOR RADIO RESOURCE CONTROL CONNECTION

(71) Applicants: Pingping Wen, Shanghai (CN); Yun Deng, Shanghai (CN); Chandrika Worrall, Newbury (GB)

(72) Inventors: Pingping Wen, Shanghai (CN); Yun Deng, Shanghai (CN); Chandrika Worrall, Newbury (GB)

(73) Assignee: Alcatel Lucent, Boulogne Billancourt (FR)

(21) Appl. No.: 14/910,079

(22) PCT Filed: Jul. 21, 2014
(86) PCT No.: PCT/IB2014/001536

§ 371 Date: Feb. 4, 2016

(30) Foreign Application Priority Data
Aug. 6, 2013 (CN) 201310340756.6

(51) Int. Cl. H04W 76/02; H04W 76/04; H04W 76/06

(52) U.S. Cl. CPC H04W 76/025; H04W 76/027; H04W 76/028; H04W 76/064; H04W 76/045; H04W 84/045

(57) ABSTRACT

Embodiments of the present invention provide a method and apparatus for radio resource control connection and a method and an apparatus for solving radio link degradation, wherein user equipment (UE) may establish radio connections to two/plural cells. The method comprises: determining that at least one of the radio connections established by the UE and two/plural cells occur connection failure; and executing radio resource control (RRC) connection to implement dual/plural connectivity with the two/plural cells.

### FIELD OF THE INVENTION

Embodiments of the present invention generally relate to the field of communications, and more specifically to a method and apparatus for radio resource control connection and a method and an apparatus for solving radio link degradation.

### BACKGROUND OF THE INVENTION

At present, due to a gain for the capacity improvement and a gain in respect of blind spot coverage brought about by a low power node, focus of more and more studies is directed to small cell deployments and enhancements covered by the low power node. Here, the small power node may be a small-sized base station, and its example includes but is not limited to low power base stations such as Pico or Femto. In 3GPP R12, one new Study Item “Small Cell Enhancements for E-UTRA and E-UTRAN—Higher-layer aspects” has been approved and one important point therein is to support dual/plural connectivity to a macro cell (a cell where a macro base station provides coverage) and a small cell layer.

The dual/plural connectivity means that one or two/plural macro cells have connections with one or two/plural small cells, wherein each cell of these macro cells and small cells has a different function, for example, the macro cell connected with MME acts as anchoring cell which provides good coverage and the small cell may implement data offloading from the macro cell.

Since there are two/plural serving cells as well as two/plural serving links, it is possible that radio link degradation or radio link failure (RLF), integrity check failure and/or RRC connection reconfiguration failure occur in one or plural links. However, relevant technologies do not define how to operate when the above situations occur.

### SUMMARY OF THE INVENTION

As relevant technologies do not define, with respect to dual/plural connectivity, how to operate when the RLF, integrity check failure and/or RRC connection reconfiguration failure occur in one or more links, embodiments of the present invention provide a method and apparatus for radio resource control connection and a method and an apparatus for solving radio link degradation.

According to one aspect of embodiments of the present invention, there is provided a method for radio resource control connection, wherein user equipment (UE) may establish radio connections to two/plural cells. The method comprises: determining that at least one of the radio connections established by the UE and two/plural cells occur connection failure; and executing radio resource control (RRC) connection to implement dual/plural connectivity with the two/plural cells.

In an embodiment, the connection failure comprises at least one of radio link failure, integrity check failure and RRC connection reconfiguration failure.

In an embodiment, the UE establishes radio connection with at least one macro cell and at least one small cell.

In an embodiment, in the case that the UE determines connection failure occurs only in the macro cell and keeps connection with the small cell, cell selection is executed and an RRC Connection Reestablishment Request message is sent to the selected cell, wherein the RRC Connection Reestablishment Request message carries an indicator to indicate request for dual/plural connectivity.

In an embodiment, in the case that the dual/plural connection is not supported in the selected cell after successful transmission of RRC Connection Reestablishment Request message to the selected cell, the selected cell sends an RRC Connection Reestablishment Reject message to the UE; and/or in the case that the selected cell is a small cell and the dual/plural connectivity to two/plural small cells is not permitted, the selected cell sends the RRC Connection Reestablishment Reject message to the UE.

In an embodiment, when the UE receives the RRC Connection Reestablishment Reject message, the UE informs the small cell that there will be only a connectivity with the small cell, so that the small cell requests UE context from the macro cell and/or requests a mobility management entity to switch S1 path from the macro cell to the small cell for the UE.

In an embodiment, upon establishing the dual/plural connectivity, the macro cell sends the UE context to the small cell.

In an embodiment, in the case that the UE determines that the connection failure occurs only in the macro cell, the UE releases connection with the small cell and executes operation of RRC connection Reestablishment.

In an embodiment, the cell that the UE selects for connecting during the operation of the RRC connection Reestablishment is the cell that the connection is released.

In an embodiment, in the case that the UE determines connection failure occurs only in the macro cell, the UE releases the connection with the macro cell and changes the small cell as an anchoring cell.

In an embodiment, the UE informs the small cell to request the UE context from the macro cell and/or request the mobility management entity to switch S1 path from the macro cell to the small cell for the UE.

In an embodiment, upon establishing the dual/plural connectivity, the macro cell sends the UE context to the small cell.

In an embodiment, in the case that a message about anchoring cell change notification is not received within a first predetermined period of time after occurrence of the connection failure with the UE, the UE executes a conventional Reestablishment procedure.

In an embodiment, in the case that the UE determines that the connection failure occurs only in the small cell, the UE keeps the connection with the macro cell and releases the connection with the small cell.

In an embodiment, the UE may inform occurrence of connection failure in the small cell and the measurement reports of other cells to the macro cell.

In an embodiment, the macro cell executes operation of looking up the other cells and establishes dual/plural connectivity.

In an embodiment, the UE may inform the macro cell that the connection failure has already occurred in the small cell with RRC signaling.

In an embodiment, the measurement report of the other cells only includes the measurement reports of small cells.

In an embodiment, in the case that the UE determines that the connection failure occurs only in the small cell and keeps connection with the macro cell, cell selection is executed and an RRC Connection Reestablishment Request message is sent to the selected cell, wherein the RRC Connection Reestablishment Request message carries an indicator to indicate request for dual/plural connectivity.

In an embodiment, in the case that the dual/plural connection is not supported in the selected cell after successful transmission of RRC Connection Reestablishment Request message to the selected cell, the selected cell sends an RRC Connection Reestablishment Reject message to the UE; and/or in the case that the selected cell is a macro cell and the dual/plural connectivity to two/plural small cells is not permitted, the selected cell sends the RRC Connection Reestablishment Reject message to the UE.

In an embodiment, when the UE receives the RRC Connection Reestablishment Reject message, the UE informs the macro cell that there will be only a connectivity with the macro cell, or the small cell informs the macro cell that there is only a connection with the macro cell so that the macro cell executes a procedure of initiating Reestablishment of new dual/plural connectivity.

In an embodiment, in the case that the connection failure occurs in both the macro cell and the small cell, the UE executes a conventional Reestablishment procedure.

According to another aspect of embodiments of the present invention, there is provided a method for solving radio link degradation, wherein user equipment (UE) may establish radio connection with at least one macro cell and at least one small cell. The method comprises: determining whether the link quality between the UE and the small cell degrades; if the link quality between the UE and the small cell degrades, reporting small cell quality degradation to the macro cell and report the measurement report of other cells to the macro cell, so that the macro cell switches the small cell path from the small cell where link quality degradation has already occurred to other cells to maintain connection of dual/plural cells without executing radio link monitoring by the small cell and without initiating radio link failure.

According to a further aspect of embodiments of the present invention, there is provided a method for solving radio link degradation, wherein user equipment (UE) may establish radio connection with at least one macro cell and at least one small cell. The method comprises: obtaining a report on link quality degradation between the UE and the small cell and the measurement reports of other cells, and switching the small cell path from the small cell where link quality degradation has already occurred to other cells to maintain connection of two/plural cells.

In an embodiment, the channel quality degradation is obtained based on channel quality-related measurement.

In an embodiment, the quality degradation of the small cell is reported by the UE to the macro cell.

According to another aspect of embodiments of the present invention, there is provided an apparatus for a radio resource control connection, wherein user equipment (UE) may establish radio connection with two/plural cells. The apparatus comprises: a determining unit configured to determine that at least one of the radio connections established by the UE and two/plural cells occur connection failure, and an executing unit configured to execute radio resource control (RRC) connection to implement dual/plural connectivity with the two/plural cells.

In an embodiment, the connection failure comprises at least one of radio link failure, integrity check failure and RRC connection reconfiguration failure.

In an embodiment, the UE establishes radio connection with at least one macro cell and at least one small cell.

In an embodiment, in the case that the UE determines connection failure occurs only in the macro cell and keeps connection with the small cell, cell selection is executed and an RRC Connection Reestablishment Request message is sent to the selected cell, wherein the RRC Connection Reestablishment Request message carries an indicator to indicate request for dual/plural connectivity.

In an embodiment, in the case that the dual/plural connection is not supported in the selected cell after successful transmission of RRC Connection Reestablishment Request message to the selected cell, the selected cell sends an RRC Connection Reestablishment Reject message to the UE; and/or in the case that the selected cell is a small cell and the dual/plural connectivity to two/plural small cells is not permitted, the selected cell sends the RRC Connection Reestablishment Reject message to the UE.

In an embodiment, when the UE receives the RRC Connection Reestablishment Reject message, the UE informs the small cell that there will be only a connectivity with the small cell, so that the small cell requests UE context from the macro cell and/or requests a mobility management entity to switch S1 path from the macro cell to the small cell for the UE.

In an embodiment, upon establishing the dual/plural connectivity, the macro cell sends the UE context to the small cell.

In an embodiment, in the case that the UE determines that the connection failure occurs only in the macro cell, the UE releases connection with the small cell and executes operation of RRC connection Reestablishment.

In an embodiment, the cell that the UE selects for connecting during the operation of the RRC connection Reestablishment is the cell that the connection is released.

In an embodiment, in the case that the UE determines connection failure occurs only in the macro cell, the UE releases the connection with the macro cell and the small cell is changed as an anchoring cell.

In an embodiment, the UE informs to request the UE context from the macro cell and/or request the mobility management entity to switch S1 path from the macro cell to the small cell for the UE.

In an embodiment, upon establishing the dual/plural connectivity, the macro cell sends the UE context to the small cell.

In an embodiment, in the case that the Reestablishment message about anchoring cell change notification is not received within a first predetermined period of time after occurrence of the connection failure with the UE, the UE executes a conventional Reestablishment procedure.

In an embodiment, in the case that the UE determines that the connection failure occurs only in the small cell, the UE keeps the connection with the macro cell and releases the connection with the small cell.

In an embodiment, the UE may inform occurrence of connection failure in the small cell and the measurement reports of other cells to the macro cell.

In an embodiment, the macro cell executes operation of looking up the other cells and establishes dual/plural connectivity.

In an embodiment, the UE may inform the macro cell that the connection failure has already occurred in the small cell with RRC signaling.

In an embodiment, the measurement report of the other cells only includes the measurement reports of small cells.

In an embodiment, in the case that the UE determines that the connection failure occurs only in the small cell and keeps connection with the macro cell, cell selection is executed and an RRC Connection Reestablishment Request message is sent to the selected cell, wherein the RRC Connection Reestablishment Request message carries an indicator to indicate request for dual/plural connectivity.

In an embodiment, in the case that the dual/plural connection is not supported in the selected cell after successful transmission of RRC Connection Reestablishment Request message to the selected cell, the selected cell sends an RRC Connection Reestablishment Reject message to the UE; and/or in the case that the selected cell is a macro cell and the dual/plural connectivity to two/plural small cells is not permitted, the selected cell sends the RRC Connection Reestablishment Reject message to the UE.

In an embodiment, when the UE receives the RRC Connection Reestablishment Reject message, the UE informs the macro cell that there will be only a connectivity with the macro cell, or the small cell informs the macro cell that there is only a connection with the macro cell so that the macro cell executes a procedure of initiating Reestablishment of new dual/plural connectivity.

In an embodiment, in the case that the connection failure occurs in both the macro cell and the small cell, the UE executes a conventional Reestablishment procedure.

According to another aspect of embodiments of the present invention, there is provided an apparatus for solving radio link degradation, wherein user equipment (UE) may establish radio connection with at least one macro cell and at least one small cell. The apparatus comprises: a determining unit configured to determine whether the link quality between the UE and the small cell degrades, a reporting unit configured to, if the link quality between the UE and the small cell degrades, report small cell quality degradation to the macro cell and the measurement reports of other cells to the macro cell, so that the macro cell switches a small cell path from the small cell where link quality degradation has already occurred to other cells to maintain connection of dual/plural cells without executing radio link monitoring by the small cell and without initiating radio link failure.

According to a further aspect of embodiments of the present invention, there is provided an apparatus for solving radio link degradation, wherein user equipment (UE) may establish radio connection with at least one macro cell and at least one small cell. The apparatus comprises: an obtaining unit configured to obtain a report on link quality degradation between the UE and the small cell and the measurement reports of other cells, and a switching unit configured to switch a small cell path from the small cell where link quality degradation has already occurred to other cells to maintain connection of two/plural cells.

In an embodiment, the channel quality degradation is obtained based on channel quality-related measurement.

In an embodiment, the quality degradation of the small cell is reported by the UE to the macro cell.

According to a further aspect of embodiments of the present invention, there is provided a computer program product, including computer program instructions for executing the above aspects.

### BRIEF DESCRIPTION OF DRAWINGS

The above and other objects, features and advantages of embodiments of the present invention will be made more apparent by reading the following detailed description with reference to the figures. In the figures, several embodiments of the present invention will be illustrated in an exemplary and unrestrictive manner, wherein:

FIG. 1 illustrates a flow chart of a method for a radio resource control connection according to an embodiment of the present invention;

FIG. 2 illustrates a flow chart of a method for solving radio link degradation according to an embodiment of the present invention;

FIG. 3 illustrates a flow chart of a method for solving radio link degradation according to another embodiment of the present invention;

FIG. 4 illustrates a block diagram of an apparatus for a radio resource control connection according to an embodiment of the present invention;

FIG. 5 illustrates a block diagram of an apparatus for solving radio link degradation according to an embodiment of the present invention;

FIG. 6 illustrates a block diagram of an apparatus for solving radio link degradation according to another embodiment of the present invention.

In the figures, identical or corresponding reference signs denote identical or corresponding parts.

### DETAILED DESCRIPTION OF PREFERRED EMBODIMENTS

Principles and spirit of the present invention will be described with reference to several exemplary embodiments illustrated in the figures. It should be appreciated that these embodiments are presented only to enable those skilled in the art to better understand and thereby implement the present invention, not to limit the scope of the present invention in any manner.

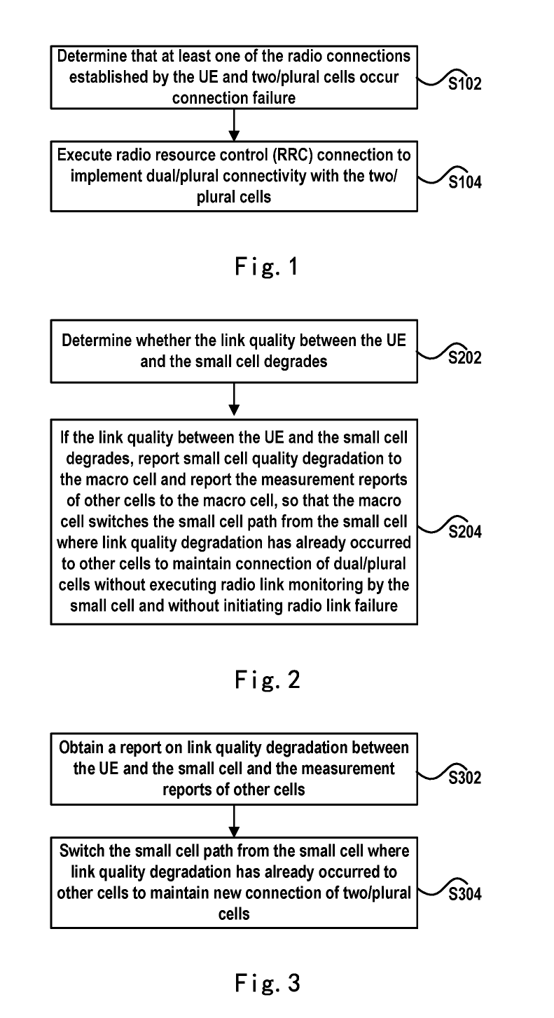

FIG. 1 illustrates a flow chart of a method for a radio resource control connection according to an embodiment of the present invention, wherein user equipment (UE) may establish radio connections to two/plural cells. The method comprises the following Step S102 and Step S104.

Step S102: determining that at least one of the radio connections established by the UE and two/plural cells occur connection failure.

Step S104: executing radio resource control (RRC) connection to implement dual/plural connectivity with the two/plural cells.

Regarding the above “connection failure”, although those skilled in the art may directly and undoubtedly determine its meaning, embodiments of the present invention still clarify it as follows:

Firstly, the radio link failure may comprise radio link failure caused by T310 expiry, random access problem and maximum re-transmission number on RLC.

Secondly, a plurality of security keys are used for dual/plural connectivity, the UE might suffer from integrity check failure in the macro cell or the small cell.

Thirdly, the UE may suffer RRC connection reconfiguration failure in the macro cell. If C2 (control plane architecture C2) is adopted, the UE might suffer from the RRC connection reconfiguration failure in the small cell.

Finally, the present invention might cover connection failure caused by different causes and occurring in the macro cell and the small cell, i.e., the UE might suffer from integrity check failure in the small cell while suffering from radio link failure in the macro cell.

Those skilled in the art may appreciate that Step S102 includes many possible cases involving connection failure occurring in dual/plural cells. For the sake of clear description, the cases are classified into three cases and described respectively, namely, connection failure occurring only in the macro cell as a main/anchoring cell, connection failure occurring only in the small cell as an auxiliary cell, and connection failure occurring in both the macro cell and the small cell.

Scenario 1: The UE Suffers from Connection Failure Only in the Macro Cell

Since the small cell and the macro cell in the dual/plural connectivity might operate at different frequencies, it is beneficial to allow the UE to reconnect to the small cell or maintain connection to the small cell when it suffers from connection failure in the macro cell.

Solution 1: keep the connection with the small cell as well as trigger Reestablishment.

Firstly, the UE keeps connection with the small cell and performs cell selection. The UE may execute cell selection on any frequency including the frequency of the small cell, or may execute cell selection on any frequency not including the frequency of the small cell. For example, in the example in which dual connectivity is performed with the macro cell and the small cell, regarding the former, since the small cell might be a cell with the best channel quality on the frequency, the small cell and the selected cell might operate at the same frequency, so this requires the system to support the case of inter-cell same-frequency operation; in contrast, regarding the latter, since the small cell and the selected cell will operate at different frequencies, this requires to system to support the case in which operation is performed at different frequencies among cells.

Secondly, the UE sends the RRC Connection Reestablishment Request message to the selected cell, and the RRC Connection Reestablishment Request message carries an indicator to indicate request for dual/plural connectivity. For example, if the UE selects LTE RAT cell, it performs random access procedure and sends RRC Connection Reestablishment Request. One indicator in the RRC connection Reestablishment request is needed to indicate there is already one serving link with the UE, the Reestablishment is to request the dual/plural connectivity. However, even if in the event of success in sending RRC Connection Reestablishment Request, the selected cell may not support dual/plural connectivity, so the cell will send the RRC Connection Reestablishment Reject message to the UE. Alternatively, in the case that the cell selected by the UE is a small cell and the dual/plural connectivity to two/plural small cells is not permitted, the selected cell will also send the RRC Connection Reestablishment Reject message to the UE even if in the event of success in sending RRC Connection Reestablishment Request.

Thirdly, after the UE receives the RRC Connection Reestablishment Reject message, it will inform the small cell that there will be only a connectivity with the small cell. For example, in an example in which dual connectivity is performed with the macro cell and the small cell, the UE will report to the small cell to indicate there will be only a connectivity with the small cell. At this time, the small cell will require a UE context from the macro cell. Besides, the small cell also needs to request the MME to switch S1 path from the macro cell to the small cell for the UE. Furthermore, regarding the UE context from the macro cell, there is another possibility that the macro cell sends the UE context to the small cell when establishing dual/plural connectivity.

Solution 2: release the connection with small cell and trigger RRC connection Reestablishment. The cell that the UE selects for connecting during the operation of the RRC connection Reestablishment is the cell that the connection is released. If the selected cell is not duly prepared or the selected cell is not an LTE RAT cell, the RRC connection Reestablishment fails and the UE turns to idle.

Solution 3: the UE releases the connection with the macro cell and the small cell is changed as an anchoring cell. As the small cell link is active, the UE sends a message to the network indicating that the RLF has occurred in the macro cell. The network prepares the small cell as the anchoring cell and informs the UE of the new configuration: the change of anchoring cell. This procedure results in fast anchoring cell change and reduces user plane interruption.

Furthermore, in the example in which dual connectivity is performed with the macro cell and the small cell, since the small cell might not know some UE context, the UE will inform the small cell to obtain the UE context and/or request an mobility management entity to switch S1 path from the macro cell to the small cell for the UE. Furthermore, regarding the UE context from the macro cell, there is another possibility that the macro cell sends the UE context to the small cell when establishing dual/plural connectivity.

Scenario 2: UE Suffers from Connection Failure Only in a Small Cell

Solution 1: keep the connection with the macro cell and release the connection with the small cell, and simultaneously the UE may inform the connection failure state in the small cell with RRC signaling to the macro cell as well as the measurement report of other cell to the macro cell. The macro cell may find another small cell to keep the dual/plural connectivity.

In a conventional system, the UE MAC informs the UE RRC of RA or RLC problem and the RRC generates connection reestablishment request. In the example in which dual connectivity is performed with the macro cell and the small cell, the connection of the macro cell is good and active, and the macro cell acts as the anchoring cell and owns entire UE context. Therefore the UE MAC may inform the UE RRC. The UE RRC generates a message to the network informing the connection failure of the small cell. Moreover, the UE also sends the measurement report to the macro cell. Therefore, the macro cell will not continue to send downlink data to the small cell again. Simultaneously the macro cell may find another suitable small cell to maintain dual connectivity.

Solution 2: keep the connection with the macro cell and trigger establishment

Firstly, the UE keeps connection with the small cell and performs cell selection. Furthermore, the UE may execute cell selection on any frequency including the frequency of the small cell, or may execute cell selection on any frequency not including the frequency of the small cell. For example, in the example in which dual connectivity is performed with the macro cell and the small cell, regarding the former, since the macro cell might be a cell with the best channel quality on the frequency, the macro cell and the selected cell might operate at the same frequency, so this requires the system to support inter-cell same-frequency operation; in contrast, regarding the latter, since the macro cell and the selected cell will operate at different frequencies, this requires to system to support the case in which operation is performed at different frequencies among cells.

Secondly, the UE send the RRC Connection Reestablishment Request message to the selected cell, and the RRC Connection Reestablishment Request message carries an indicator to indicate request for dual/plural connectivity. For example, if the UE selects LTE RAT cell, it performs random access procedure and sends RRC Connection Reestablishment Request. One indicator in the RRC connection Reestablishment request is needed to indicate there is already one serving link with the UE, the Reestablishment is to request the dual/plural connectivity. However, even if in the event of success in sending Connection Reestablishment Request, the selected cell may not support dual/plural connectivity, so the cell will send the RRC Connection Reestablishment Reject message to the UE. Alternatively, in the case that the cell selected by the UE is a macro cell and the dual/plural connectivity to two/plural small cells is not permitted, the selected cell will also send the RRC Connection Reestablishment Reject message to the UE even if in the event of success in sending RRC Connection Reestablishment Request.

Thirdly, after the UE receives the RRC Connection Reestablishment Reject message, it will report to the macro cell to indicate there will be only a connectivity with the macro cell. For example, in the example in which dual connectivity is performed with the macro cell and the small cell, the UE will report to the macro cell to indicate there will be only a connectivity with the small cell.

Scenario 3: UE suffers from connection failure in both the macro cell and the small cell simultaneously.

In this scenario, the UE should initiate the Reestablishment procedure because there is no available radio link for the UE. However, this scenario occurs very rarely.

Besides, in LTE system, the UE monitors the situation of the radio link via a Radio Link Monitor (RLM). For example, the UE executes the CQI measurement, if the long term average wideband CQI is below Qout, the T310 will be triggered and begin running, it represented that the radio link condition is bad. If the T310 is expired, the RLF is declared by the UE. In addition, if there is problem with Random access and maximum re-transmission number on a radio link control (RLC) layer, the RLF will also occur. If RLF occurs, the user will try to execute the RRC connection Reestablishment. If the RRC connection Reestablishment can't be successful in the defined time, the UE will come back to idle state from the connected state.

The above flow may be optimized through method of solving radio link failure as shown in FIG. 2. FIG. 2 illustrates a flow chart of a method for solving radio link failure according to an embodiment of the present invention, wherein the method comprises the following step S202 and step S204.

Step S202: determining whether the link quality between the UE and the small cell degrades.

Step S204: if the link quality between the UE and the small cell degrades, reporting small cell quality degradation to the macro cell and reporting the measurement report of other cell to the macro cell, so that the macro cell switches the small cell path from the small cell where link quality degradation has already occurred to other cells to maintain connection of dual/plural cells without executing radio link monitoring by the small cell and without initiating radio link failure.

As known from step S202 and S204, in the case of dual/plural connectivity and if channel quality of one or two/plural small cells in a defined time is lower, the UE may report to the macro cell that channel quality has degraded in these cells and meanwhile the user also reports the measurement report of other cells to the macro cell, so that the macro cell switches the small cell path to other cells with higher channel quality according to the above information. For example, in the example in which dual connectivity is performed with the macro cell and the small cell, if the channel quality of the small cell in a defined time is lower, the UE may report to the macro cell that channel quality has degraded in the small cell and meanwhile report the measurement report of other cells to the macro cell, and then the macro cell may find a suitable small cell and switch the small cell path to the found small cell to support new dual/plural connectivity. Particularly noticeably, different from solutions in relevant technologies, the solution provided by embodiments of the present invention needn't wait for the above T310 expiry and RLC occurrence in the small cell without executing radio link monitoring by the small cell and without initiating radio link failure. Therefore, this may reduce the time period when the UE is in a state of undesirable radio link conditions.

Correspondingly, FIG. 3 illustrates a flow chart of a method for solving radio link failure according to another embodiment of the present invention, comprising step S302 to step S304 as shown in FIG. 3.

Step S302: obtaining a report on link quality degradation between the UE establishing radio connection with at least one macro cell and at least one small cell and the small cell and a report on measurement of other cells.

Step S304: switching the small cell path from the small cell where link quality degradation has already occurred to other cells to maintain new connection of two/plural cells.

Wherein the channel quality degradation is obtained based on channel quality-related measurement. The quality degradation of the small cell is reported by the UE to the macro cell.

Embodiments of the present invention further provide an apparatus for a radio resource control connection, wherein the user equipment (UE) may establish radio connection with two/plural cells.

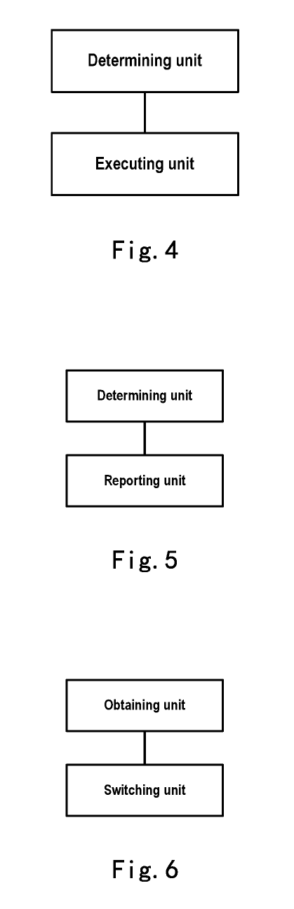

FIG. 4 illustrates a block diagram of an apparatus for a radio resource control connection according to an embodiment of the present invention. The apparatus comprises: a determining unit and an executing unit. The structure of the units will be described in detail.

The determining unit is configured to determine that at least one of the radio connections established by the UE and two/plural cells occur connection failure. The executing unit is connected to the determining unit and configured to execute radio resource control (RRC) connection to implement dual/plural connectivity with the two/plural cells.

Those skilled in the art may appreciate that the determining unit may determine many possible cases involving connection failure occurring in dual/plural cells. For the sake of clear description, the cases are classified into three cases and described respectively, namely, connection failure occurring only in the macro cell as a main/anchoring cell, connection failure occurring only in the small cell as an auxiliary cell, and connection failure occurring in both the macro cell and the small cell.

Scenario 1: The Determining Unit Determines that Connection Failure Occurs Only in a Macro Cell

Since the small cell and the macro cell in the dual/plural connectivity might operate at different frequencies, it is beneficial to allow the UE to reconnect to the small cell or maintain connection to the small cell when it suffers from connection failure in the macro cell.

Solution 1: keep the connection with the small cell as well as trigger Reestablishment.

Firstly, the executing unit keeps connection with the small cell and performs cell selection. The UE may execute cell selection on any frequency including the frequency of the small cell, or may execute cell selection on any frequency not including the frequency of the small cell. For example, in the example in which dual connectivity is performed with the macro cell and the small cell, regarding the former, since the small cell might be a cell with the best channel quality on the frequency, the small cell and the selected cell might operate at the same frequency, so this requires the system to support the case of inter-cell same-frequency operation; in contrast, regarding the latter, since the small cell and the selected cell will operate at different frequencies, this requires to system to support the case in which operation is performed at different frequencies among cells.

Secondly, the executing unit sends the RRC Connection Reestablishment Request message to the selected cell, and the RRC Connection Reestablishment Request message carries an indicator to indicate request for dual/plural connectivity. For example, if the UE selects LTE RAT cell, it performs random access procedure and sends RRC Connection Reestablishment Request. One indicator in the RRC connection Reestablishment request is needed to indicate there is already one serving link with the UE, the Reestablishment is to request the dual/plural connectivity. However, even if in the event of success in sending RRC Connection Reestablishment Request, the selected cell may not support dual/plural connectivity, so the cell will send the RRC Connection Reestablishment Reject message to the UE. Alternatively, in the case that the cell selected by the executing unit is a small cell and the dual/plural connectivity to two/plural small cells is not permitted, the selected cell will also send the RRC Connection Reestablishment Reject message to the UE even if in the event of success in sending RRC Connection Reestablishment Request.

Thirdly, after the UE receives the RRC Connection Reestablishment Reject message, the executing unit will inform the small cell that there will be only a connectivity with the small cell. For example, in an example in which dual connectivity is performed with the macro cell and the small cell, the executing unit will report to the small cell to indicate there will be only a connectivity with the small cell. At this time, the small cell will require a UE context from the macro cell. Besides, the small cell also needs to request the MME to switch S1 path from the macro cell to the small cell for the UE. Furthermore, regarding the UE context from the macro cell, there is another possibility that the macro cell sends the UE context to the small cell when establishing dual/plural connectivity.

Solution 2: release the connection with small cell and trigger RRC connection Reestablishment. The cell that the UE selects for connecting during the operation of the RRC connection Reestablishment is the cell that the connection is released. If the selected cell is not duly prepared or the selected cell is not an LTE RAT cell, the RRC connection Reestablishment fails and the UE turns to idle.

Solution 3: the executing unit releases the connection with the macro cell and the small cell is changed as an anchoring cell. As the small cell link is active, the executing unit sends a message to the network indicating that the RLF has occurred in the macro cell. The network prepares the small cell as the anchoring cell and informs the UE of the new configuration: the change of anchoring cell. This procedure results in fast anchoring cell change and reduces user plane interruption.

Furthermore, in the example in which dual connectivity is performed with the macro cell and the small cell, since the small cell might not know some UE context, the executing unit will inform the small cell to obtain the UE context and/or request an mobility management entity to switch S1 path from the macro cell to the small cell for the UE. Furthermore, regarding the UE context from the macro cell, there is another possibility that the macro cell sends the UE context to the small cell when establishing dual/plural connectivity.

Scenario 2: The Determining Unit Determines that Connection Failure Occurs Only in a Small Cell

Solution 1: keep the connection with the macro cell and release the connection with the small cell, and simultaneously the UE may inform the connection failure state in the small cell with RRC signaling to the macro cell as well as the measurement report of other cells to the macro cell. The macro cell may find another small cell to keep the dual/plural connectivity.

In a conventional system, the UE MAC informs the UE RRC of RA or RLC problem and the RRC generates connection reestablishment request. In the example of the present invention in which dual connectivity is performed with the macro cell and the small cell, the connection of the macro cell is good and active, and the macro cell acts as the anchoring cell and owns entire UE context. Therefore, the UE MAC may inform the UE RRC. The UE RRC generates a message to the network informing the connection failure of the small cell. Moreover, the executing unit also sends the measurement report to the macro cell. Therefore, the macro cell will not continue to send downlink data to the small cell again. Simultaneously the macro cell may find another suitable small cell to maintain dual connectivity.

Solution 2: keep the connection with the macro cell and trigger establishment

Firstly, the executing unit keeps connection with the small cell and performs cell selection. Furthermore, the UE may execute cell selection on any frequency including the frequency of the small cell, or may execute cell selection on any frequency not including the frequency of the small cell. For example, in the example in which dual connectivity is performed with the macro cell and the small cell, regarding the former, since the macro cell might be a cell with the best channel quality on the frequency, the macro cell and the selected cell might operate at the same frequency, so this requires the system to support inter-cell same-frequency operation; in contrast, regarding the latter, since the macro cell and the selected cell will operate at different frequencies, this requires to system to support the case in which operation is performed at different frequencies among cells.

Secondly, the executing unit sends the RRC Connection Reestablishment Request message to the selected cell, and the RRC Connection Reestablishment Request message carries an indicator to indicate request for dual/plural connectivity. For example, if the executing unit selects LTE RAT cell, it performs random access procedure and sends RRC Connection Reestablishment Request. One indicator in the RRC connection Reestablishment request is needed to indicate there is already one serving link with the UE, the Reestablishment is to request the dual/plural connectivity. However, even if in the event of success in sending Connection Reestablishment Request, the selected cell may not support dual/plural connectivity, so the cell will send the RRC Connection Reestablishment Reject message to the UE. Alternatively, in the case that the cell selected by the executing cell is a macro cell and the dual/plural connectivity to two/plural small cells is not permitted, the selected cell will also send the RRC Connection Reestablishment Reject message to the UE even if in the event of success in sending RRC Connection Reestablishment Request.

Thirdly, after the UE receives the RRC Connection Reestablishment Reject message, the executing unit will inform the macro cell that there will be only a connectivity with the macro cell or the small cell informs the macro cell that there is only a connection with the macro cell so that the macro cell executes a procedure of initiating Reestablishment of new dual/plural connectivity. For example, in the example in which dual connectivity is performed with the macro cell and the small cell, the executing unit will report to the macro cell to indicate there will be only a connectivity with the small cell.

Scenario 3: the determining unit determines that the connection failure occurs in both the macro cell and the small cell simultaneously.

In this scenario, the UE should initiate the Reestablishment procedure because there is no available radio link for the UE. However, this scenario occurs very rarely.

Besides, in prior LTE system, the UE monitors the situation of the radio link via a Radio Link Monitor (RLM). For example, the UE executes the CQI measurement, if the long term average wideband CQI is below Qout, the T310 will be triggered and begin running, it represented that the radio link condition is bad. If the T310 is expired, the RLF is declared by the UE. In addition, if there is problem with Random access and maximum re-transmission number on a radio link control (RLC), the RLF will also occur. If RLF occurs, the user will try to execute the RRC connection Reestablishment. If the RRC connection Reestablishment can't be successful in the defined time, the UE will come back to idle state from the connected state.

However, the above flow may be optimized through an apparatus of solving radio link failure as shown in FIG. 5. FIG. 5 illustrates a block diagram of an apparatus for solving radio link failure according to an embodiment of the present invention, wherein the user equipment (UE) may establish radio connection with at least one macro cell and at least one small cell. The apparatus comprises: a determining unit configured to determine whether the link quality between the UE and the small cell degrades, a reporting unit configured to, if the link quality between the UE and the small cell degrades, report small cell quality degradation to the macro cell and report the measurement report of other cells to the macro cell, so that the macro cell switches the small cell path from the small cell where link quality degradation has already occurred to other cells to maintain connection of dual/plural cells without executing radio link monitoring by the small cell and without initiating radio link failure.

By using the above determining unit and reporting unit, in the case of dual/plural connectivity and if channel quality of one or two/plural small cells in a defined time is lower, the UE may report to the macro cell that channel quality has degraded in these cells and meanwhile the user reports the measurement report of other cells to the macro cell, so that the macro cell switches the small cell path to other cells with higher channel quality according to the above information. For example, in the example in which dual connectivity is performed with the macro cell and the small cell, if the channel quality of the small cell in a defined time is lower, the UE may report to the macro cell that channel quality has degraded in the small cell and meanwhile report the measurement report of other cells to the macro cell, and then the macro cell may find a suitable small cell and switch the small cell path to the found small cell to support new dual/plural connectivity. Particularly noticeably, different from solutions in relevant technologies, the solution provided by embodiments of the present invention needn't wait for the above T310 expiry and RLC occurrence in the small cell without executing radio link monitoring by the small cell and without initiating radio link failure. Therefore, this may reduce the time period when the UE is in a state of undesirable radio link conditions.

Correspondingly, FIG. 6 illustrates a block diagram of an apparatus for solving radio link failure according to another embodiment of the present invention. As shown in FIG. 6, the user equipment (UE) may establish radio connection with at least one macro cell and at least one small cell. The apparatus comprises: an obtaining unit configured to obtain a report on link quality degradation between the UE and the small cell and a report on measurement of other cells, and a switching unit configured to switch the small cell path from the small cell where link quality degradation has already occurred to other cells to maintain connection of two/plural cells.

Wherein the channel quality degradation is obtained based on channel quality-related measurement. The quality degradation of the small cell is reported by the UE to the macro cell.

To conclude, embodiments of the present invention have the following technical effects:

Firstly, embodiments of the present invention provide scenarios when radio link degradation occurs in the small cell.

Secondly, embodiments of the present invention provide scenarios of connection failure (including but are not limited to radio link failure, integrity check failure and or RRC connection reconfiguration failure) and support for Reestablishment of dual/plural connectivity. The scenarios of the present invention give full thoughts to different features of the macro cell and the small cell, for example, the macro cell, as the anchoring cell, has more information and it may determine another link of the dual/plural connectivity. Through the solutions provided by the present invention, dual/plural links may together effectively serve the UE to support the dual/plural connectivity.

In addition, operations of the method of the present invention are described in a specific order in the figures, this does not require or imply that these operations must be executed in the specific order, or that a desired result is implemented when all the illustrated operations must be executed. On the contrary, the order for executing steps described in the flow chart may be changed. Additionally or alternatively, some steps may be omitted, several steps may be combined into one step for execution, and/or one step may be divided into multiple steps for execution.

Although the present disclosure has been described with reference to several embodiments, it should be understood that the present disclosure is not limited to the disclosed embodiments. The present disclosure aims to cover various modifications and equivalent arrangements included in the spirit and scope of the attached claims. The scope of the attached claims conforms to the broadest explanation, and thereby includes all such modifications and equivalent structures and functions.

1. A method for a radio resource control connection, wherein user equipment (UE) may establish radio connections with two/plural cells, the method comprising:
determining that at least one of the radio connections established by the UE and two/plural cells occur connection failure; and
executing radio resource control (RRC) connection to implement dual/plural connectivity with the two/plural cells.

2. The method according to claim 1, wherein the connection failure comprises at least one of radio link failure, integrity check failure and RRC connection reconfiguration failure.

3. The method according to claim 1, wherein the UE establishes radio connection with at least one macro cell and at least one small cell.

4. The method according to claim 3, wherein in the case that the UE determines connection failure occurs only in the macro cell and keeps connection with the small cell, cell selection is executed and an RRC Connection Reestablishment Request message is sent to the selected cell, wherein the RRC Connection Reestablishment Request message carries an indicator to indicate request for dual/plural connectivity.

5.-7. (canceled)

8. The method according to claim 3, wherein in the case that the UE determines that the connection failure occurs only in the macro cell, the UE releases connection with the small cell and executes operation of RRC connection Reestablishment.

9. (canceled)

10. The method according to claim 3, wherein in the case that the UE determines connection failure occurs only in the macro cell, the UE releases the connection with the macro cell, and the small cell is changed as an anchoring cell.

11.-13. (canceled)

14. The method according to claim 3, wherein in the case that the UE determines that the connection failure occurs only in the small cell, the UE keeps the connection with the macro cell and releases the connection with the small cell.

15.-18. (canceled)

19. The method according to claim 3, wherein in the case that the UE determines that the connection failure occurs only in the small cell and keeps connection with the macro cell, cell selection is executed and an RRC Connection Reestablishment Request message is sent to the selected cell, wherein the RRC Connection Reestablishment Request message carries an indicator to indicate request for dual/plural connectivity.

20.-21. (canceled)

22. The method according to claim 3, wherein in the case that the connection failure occurs in both the macro cell and the small cell, the UE executes a conventional Reestablishment procedure.

23. A method for solving radio link degradation, wherein user equipment (UE) may establish radio connection with at least one macro cell and at least one small cell, the method comprising:
determining whether the link quality between the UE and the small cell degrades;
if the link quality between the UE and the small cell degrades, reporting small cell quality degradation to the macro cell and reporting the measurement reports of other cells to the macro cell, so that the macro cell switches the small cell path from the small cell where link quality degradation has already occurred to other cells to maintain connection of dual/plural cells without executing radio link monitoring by the small cell and without initiating radio link failure.

24. A method for solving radio link degradation, wherein user equipment (UE) may establish radio connection with at least one macro cell and at least one small cell, the method comprising:
obtaining a report on link quality degradation between the UE and the small cell and the measurement reports of other cells, and
switching the small cell path from the small cell where link quality degradation has already occurred to other cells to maintain new connection of two/plural cells.

25.-26. (canceled)

27. An apparatus for a radio resource control connection, wherein user equipment (UE) may establish radio connections with two/plural cells, the apparatus comprising:
a determining unit configured to determine at least one of the radio connections established by the UE and two/plural cells occur connection failure, and
an executing unit configured to execute radio resource control (RRC) connection to implement dual/plural connectivity with the two/plural cells.

28. The apparatus according to claim 27, wherein the connection failure comprises at least one of radio link failure, integrity check failure and RRC connection reconfiguration failure.

29.-48. (canceled)

49. An apparatus for solving radio link degradation, wherein user equipment (UE) may establish radio connection with at least one macro cell and at least one small cell, the apparatus comprising:
a determining unit configured to determine whether the link quality between the UE and the small cell degrades,
a reporting unit configured to, if the link quality between the UE and the small cell degrades, report small cell quality degradation to the macro cell and the measurement reports of other cells to the macro cell, so that the macro cell switches the small cell path from the small cell where link quality degradation has already occurred to other cells to maintain connection of dual/plural cells without executing radio link monitoring by the small cell and without initiating radio link failure.

50. An apparatus for solving radio link degradation, wherein user equipment (UE) may establish radio connection with at least one macro cell and at least one small cell, the apparatus comprising:
an obtaining unit configured to obtain a report on link quality degradation between the UE and the small cell and the measurement reports of other cells, and
a switching unit configured to switch the small cell path from the small cell where link quality degradation has already occurred to other cells to maintain connection of two/plural cells.

51.-52. (canceled)
